(19) United States
(12) Patent Application Publication
(10) Pub. No.: US 2011/0050667 A1
(43) Pub. Date: Mar. 3, 2011

(54) MULTISTABLE DISPLAY SYSTEM AND METHOD FOR WRITING IMAGE DATA ON MULTISTABLE DISPLAY

(75) Inventors: Wei-Hsun Huang, Tainan County (TW); Chen-Chu Tsai, Taichung County (TW); Chieh-Yi Huang, Hsinchu County (TW)

(73) Assignee: INDUSTRIAL TECHNOLOGY RESEARCH INSTITUTE, HSINCHU (TW)

(21) Appl. No.: 12/757,816

(22) Filed: Apr. 9, 2010

(30) Foreign Application Priority Data
Sep. 2, 2009 (TW) TW098129514

(51) Int. Cl. G06F 3/038

(52) U.S. Cl. 345/211

(57) ABSTRACT

A multistable display system includes a multistable display, a writehead, and a sensor. The writehead includes a plurality of electrodes for writing the pixels of the multistable display, wherein each of the pixels corresponds to at least two of the electrodes. The sensor can detect the position of the writehead relative to the multistable display. The electrodes are charged with driving voltage signals according to the relative position between the multistable display and the writehead for updating the pixels of the multistable display.

### CROSS REFERENCE TO RELATED APPLICATIONS

This Application claims priority of Taiwan Patent Application No. 098129514, filed on Sep. 2, 2009, the entirety of which is incorporated by reference herein.

### BACKGROUND OF THE INVENTION

1. Field of the Invention

This application relates in general to a multistable display system and in particular to a multistable display system capable of image updating.

2. Description of the Related Art

Multistable displays may hold images on a screen without applying voltage thereto. Thus, multistable displays are power efficient and suitable for e-books or large electronic displays which do not require frequent updating of image data. Referring to FIG. 1, a writehead W for a bistable medium 1 has been disclosed in US 2006/0170981 A1. The writehead W has a plurality of alignment protrusions W2 on an outer surface thereof, corresponding to a plurality of perforated alignment features 6 which are formed on the bistable medium 1. When the writehead W contacts and moves along the bistable medium 1, the alignment protrusions W2 engage with the perforated alignment features 6 for positioning therebetween. As shown in FIG. 1, an electrode W1 is disposed below the bistable medium 1 and respectively applies a driving voltage signal to each of the contact electrodes 9 above the bistable medium 1, so as to update the image data on the bistable medium 1.

### BRIEF SUMMARY OF INVENTION

The application provides a multistable display system, including a multistable display, a writehead, and a sensor. The writehead includes a plurality of electrodes for writing the pixels of the multistable display, wherein each of the pixels corresponds to at least two of the electrodes. The sensor can detect the position of the writehead relative to the multistable display. The electrodes are charged with driving voltage signals according to the relative position between the multistable display and the writehead for updating the pixels of the multistable display.

### BRIEF DESCRIPTION OF DRAWINGS

The invention can be more fully understood by reading the subsequent detailed description and examples with references made to the accompanying drawings, wherein:

FIG. 1 is a perspective diagram of a conventional multistable display with a writehead;

FIGS. 2A˜2C are perspective diagrams of a multistable display system according to an embodiment of the invention;

FIGS. 3A˜3B are perspective diagrams of a multistable display system according to another embodiment of the invention;

FIG. 4 is a perspective diagram of a multistable display system according to another embodiment of the invention;

FIG. 5 is a perspective diagram of a multistable display system according to another embodiment of the invention;

FIG. 6 is a perspective diagram of a multistable display system according to another embodiment of the invention; and

FIG. 7 is a perspective diagram of a multistable display system according to another embodiment of the invention.

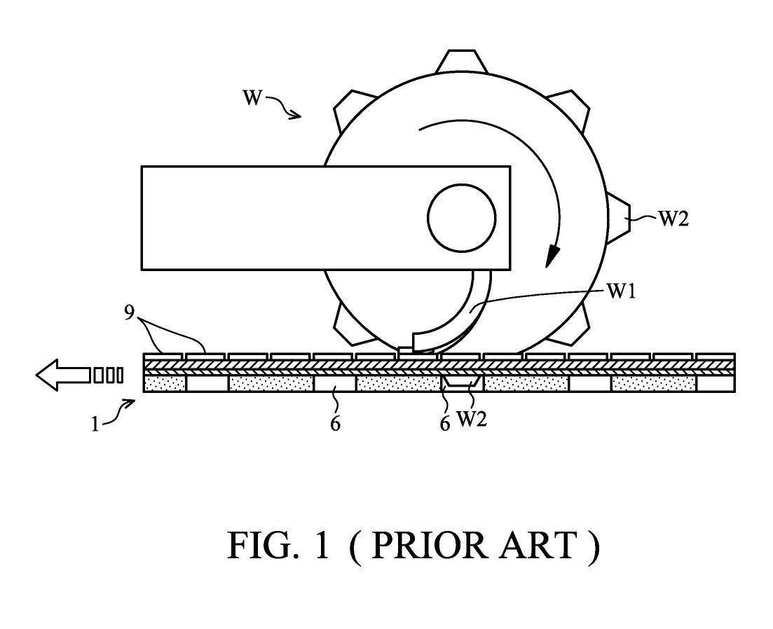

### DETAILED DESCRIPTION OF INVENTION

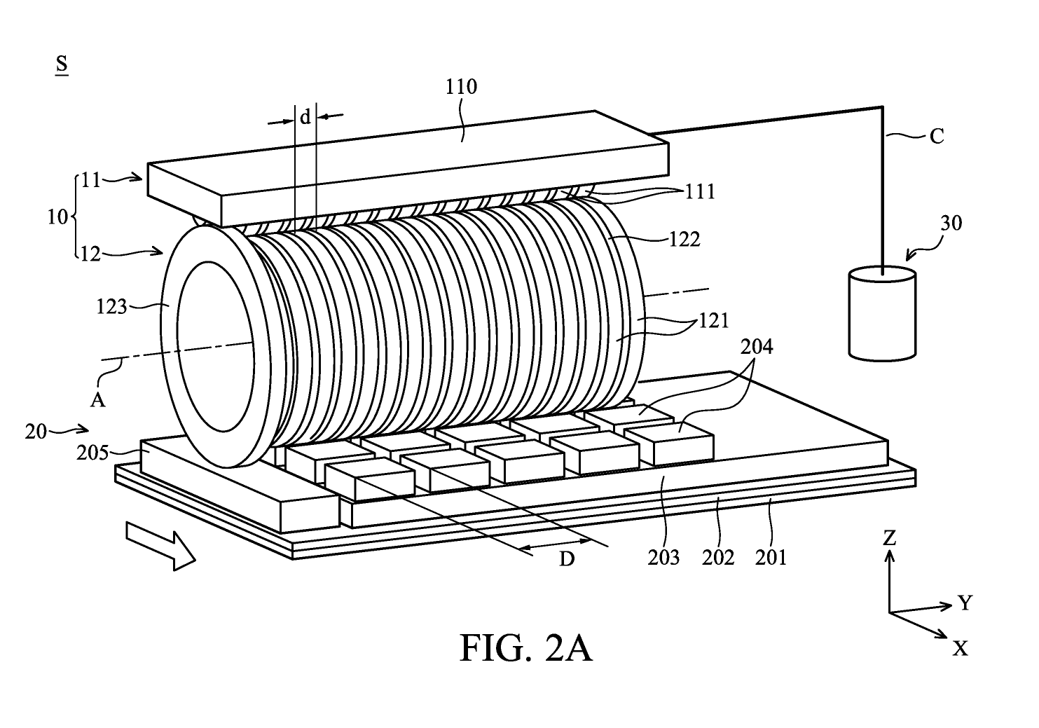

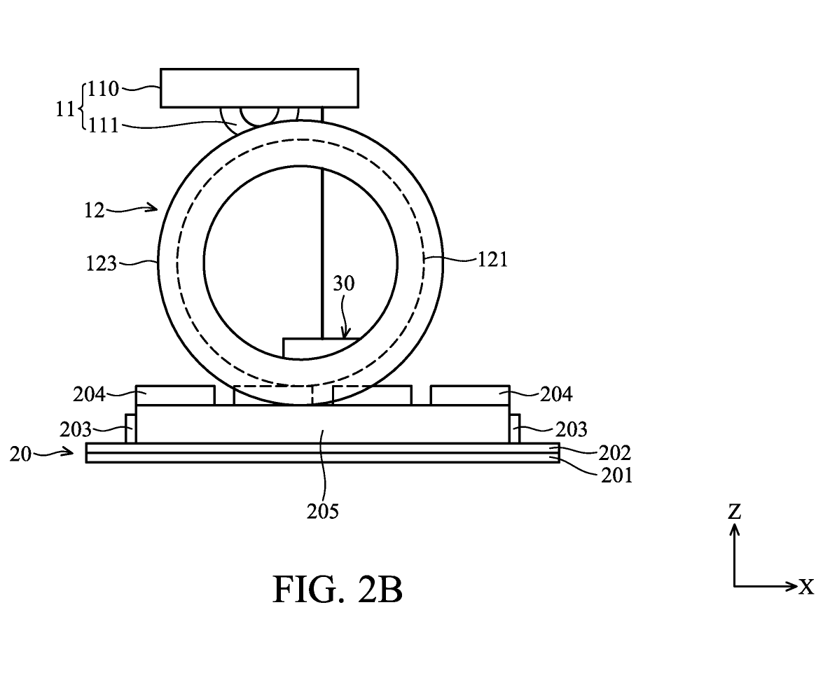

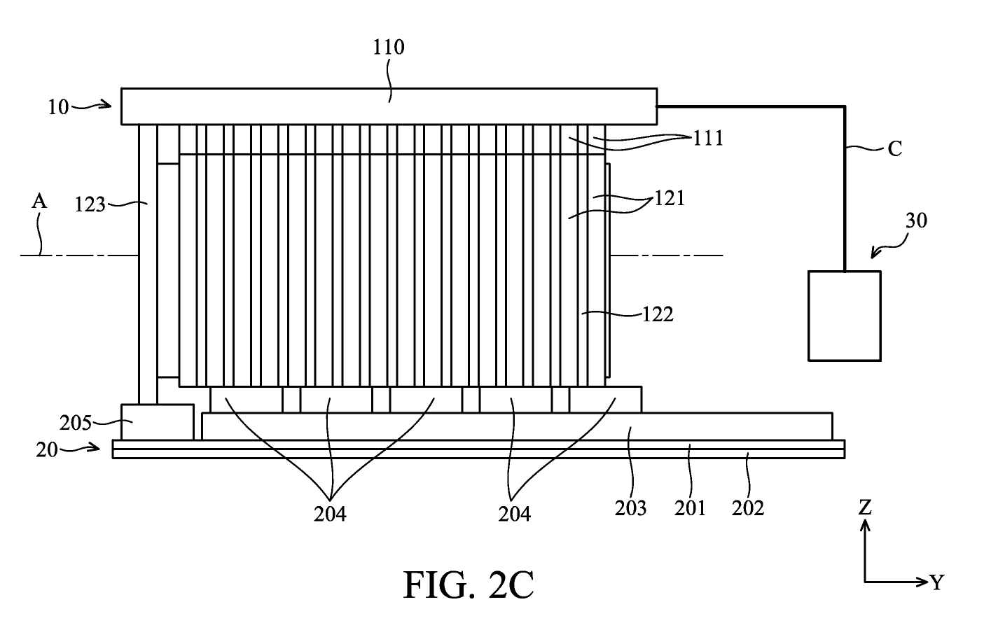

Referring to FIGS. 2A-2C, an embodiment of a multistable display system S primarily comprises a data writing device 10, a multistable display 20, and a sensor 30. The data writing device 10 comprises a driving unit 11 and a writehead 12. The driving unit 11 includes a driving circuit 110 and a plurality of brushes 111 electrically connected to the driving circuit 110. The writehead 12 is rotatable around an axis A, comprising a plurality of annular electrodes 121 and insulating portions 122 between the electrodes 121, wherein the electrodes 121 are insulated from each other by the insulating portions 122. The brushes 111 respectively contact and electrically connect to the electrodes 121. An independent electrode 123 is disposed at an end of the writehead 12 and electrically connected to a conductive portion 205 of the multistable display 20.

As shown in FIG. 2A, the multistable display 20 comprises a protection layer 201, an electrode layer 202 disposed on the protection layer 201, a multistable medium layer 203 disposed on the electrode layer 202, and a plurality of contact electrodes 204 disposed on the multistable medium layer 203. The electrode layer 202 is electrically connected with the independent electrode 123 through the conductive portion 205 disposed thereon. In some embodiments, the electrodes 121 may be block-shaped and comprise elastic conductive material for writing data on the multistable display 20. The insulating portions 122 may comprise elastic material such as rubber, and the multistable medium layer 203 may comprise cholesterol liquid crystal material. Additionally, the contact electrodes 204 may comprises silver, and the electrode layer 202 may comprise transparent ITO material.

In FIG. 2A, the contact electrodes 204 are arranged in a matrix form and electrically independent from each other, thus defining each pixel of the multistable display 20. When writing or updating image data on the multistable display 20, the multistable display 20 is moved along the X direction, as the arrow indicates in FIG. 2A. Hence, the electrodes 121 moves along the multistable display 20 and sequentially contact the contact electrodes 204 line by line, such that the electrodes 121 can provide a driving voltage signal to each contact electrode 204. The image data of each pixel is therefore updated by applying an electric field between the contact electrode 204 and the electrode layer 202.

In this embodiment, the sensor 30 is disposed beside the multistable display 20 to detect the position of the writehead 12 relative to the multistable display 20. The sensor 30 can transmit a control signal to the driving circuit 110 according to the positions of the writehead 12 and the multistable display 20. Subsequently, the driving circuit 110 provides a driving voltage signal to each of the electrodes 121 according to the control signal for rapidly and precisely updating the image on the multistable display 20. As shown in FIGS. 2A-2C, the control signal is transmitted from the sensor 30 to the driving circuit 110 through a wire C. However, the control signal can also be transmitted by wireless data transmission. In some embodiments, the driving circuit 110 may communicate with a storage medium which contains a specific image through wire or wireless transmission, so that the image data in the storage medium can be shown on the multistable display 20.

Referring to FIG. 2A, the adjacent electrodes 121 have a first distance d, and the adjacent contact electrodes 204 (the adjacent pixels) have a second distance D, wherein D>d. In this arrangement, each contact electrode 204 corresponds to at least two of the electrodes 121. Namely, each pixel can be charged by at least two of the electrodes 121. When the writehead 12 deviates from a desired position relative to the multistable display 20, such as a deviated horizontal position along the Y axis, the sensor 30 can detect the deviation (offset) of the writehead 12 and transmit a control signal to the driving circuit 110. Subsequently, the driving circuit 110 provides a driving voltage signal to each of the electrodes 121 according to the control signal. Since the first distance d is less than the second distance D, some of the driving voltage signals can be shifted and reassigned to the electrodes 121, so as to compensate for the deviated horizontal position between the writehead 12 and the multistable display 20.

As mentioned above, each of the contact electrodes 204 in the multistable display system S corresponds to several electrodes 121 for writing or updating the image data of the multistable display 20. Since the sensor 30 can detect the positions of the writehead 12 and the multistable display 20, conventional rails and perforated alignment features are not necessary. Thus, manufacturing of the multistable display 20 of the invention is less complicated and costs less than conventional multistable displays.

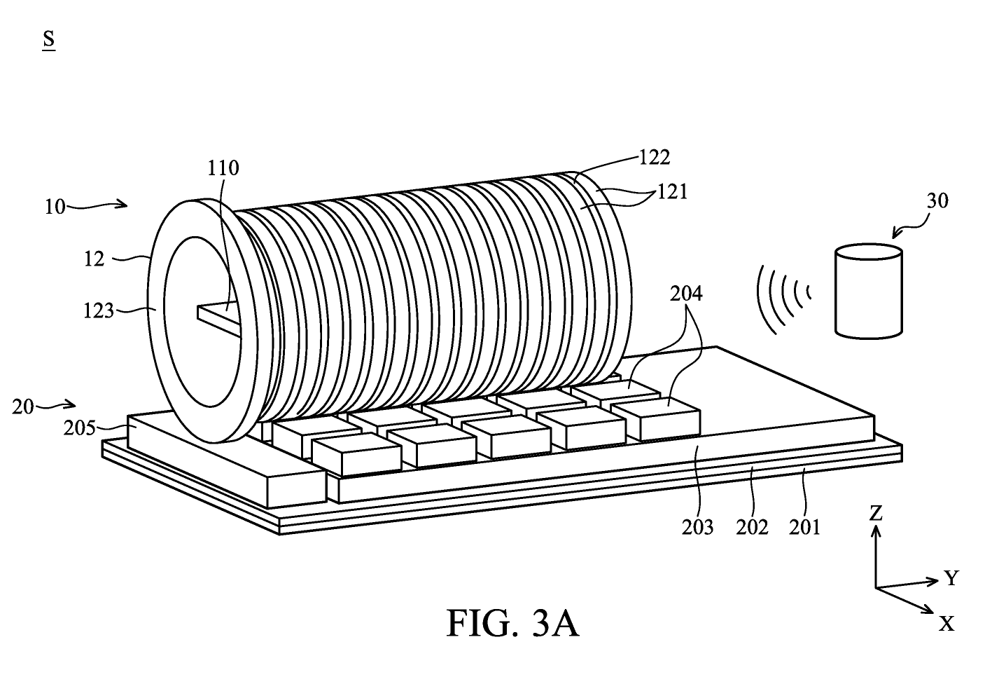

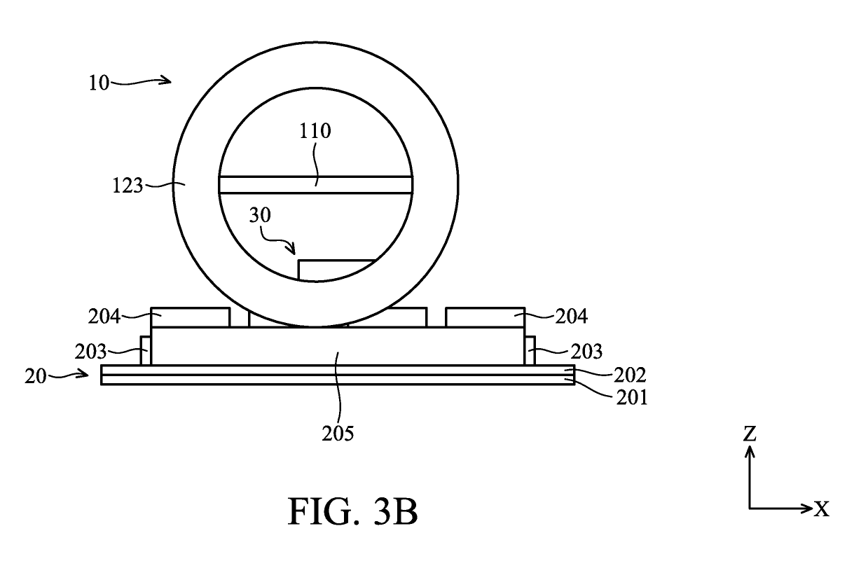

To prevent frictional wear between the brushes 111 and the electrodes 121, another embodiment of the driving circuit 110 is fixed in the writehead 12, as shown in FIGS. 3A and 3B. In this embodiment, the driving circuit 110 and the electrodes 121 are electrically connected through wires, so as to transmit the driving voltage signals to the electrodes 121. Additionally, the driving circuit 110 can communicate with the sensor 30 or other storage media by wireless data transmission to display images on the multistable display 20.

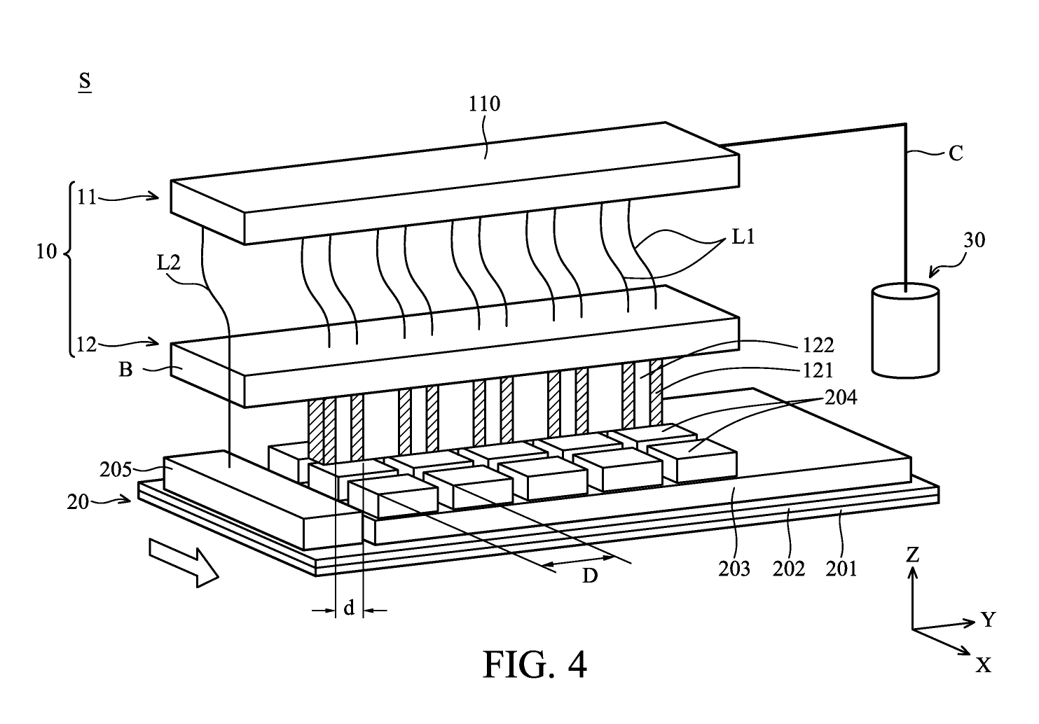

Referring to FIG. 4, another embodiment of the writehead 12 comprises a block-shaped circuit board B. A plurality of block-shaped electrodes 121 (such as conductive rubbers) and insulating portions 122 are connected to the circuit board B, such that the electrodes 121 are insulated from each other by the insulating portions 122. In FIG. 4, the driving circuit 110 is electrically connected to the electrodes 121 via the wires L1. The driving circuit 110 is further electrically connected to the conductive portion 205 via the wire L2. Similarly, each of the contact electrodes 204 in the multistable display system S corresponds to several electrodes 121 to write or update the image data of the multistable display 20.

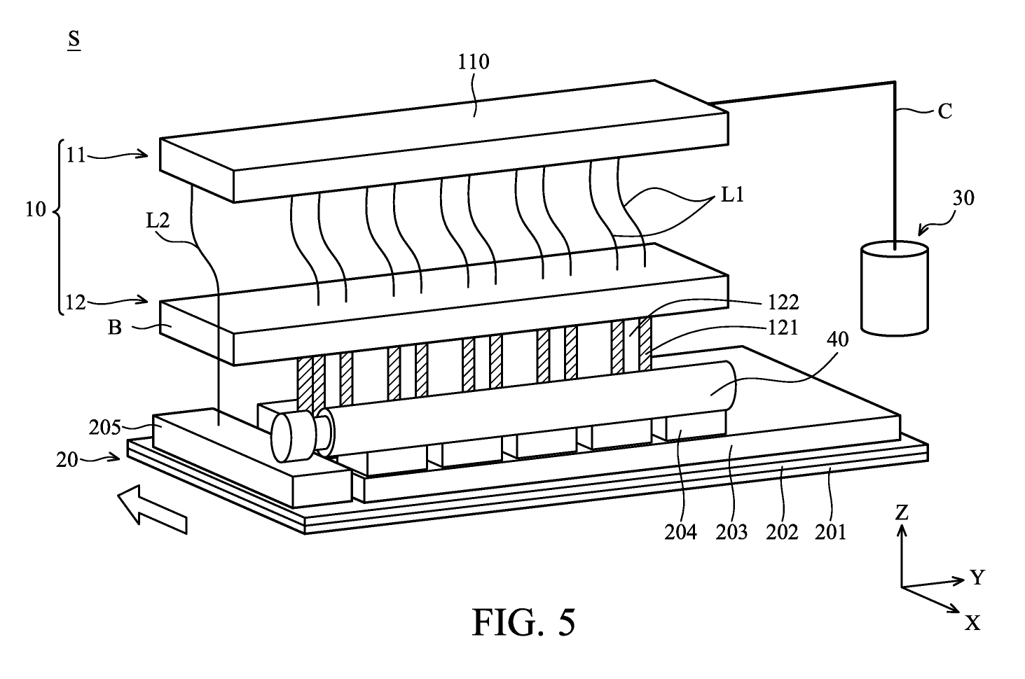

In some embodiments, the data writing device 10 can be disposed across the multistable display 20 to produce a driving electric field from the upper and lower sides thereof. Moreover, the driving circuit 110 can update and save desired image data by one time download or wireless data transmission. According to the required resolution and the detection result from the sensor 30, the circuit 110 provides a corresponding driving voltage signal to each of the electrodes 121. In some embodiments, resolution of the multistable display 20 can also be adjusted by altering the writing frequency of the data writing device 10. Referring to FIG. 5, another embodiment of a multistable display system S further comprises an erase head 40 to completely remove the image data of the multistable display 20 by moving therealong.

The data writing device 10 can also be applied to the multistable display 20 without the contact electrodes 204. Namely, the multistable display 20 forms a first non-electrode surface toward the data writing device 10 without the contact electrodes 204 disposed thereon. With regard to this configuration, the driving electric field is directly produced by the data writing device 10 and the electrode layer 202 of the multistable display 20. In some embodiments, the electrode layer 202 may be omitted from the multistable display 20 so that a second non-electrode surface is formed under the multistable display 20. Two data writing devices 10 may be respectively disposed on the upper and lower sides of the multistable display 20 to produce the driving electric field.

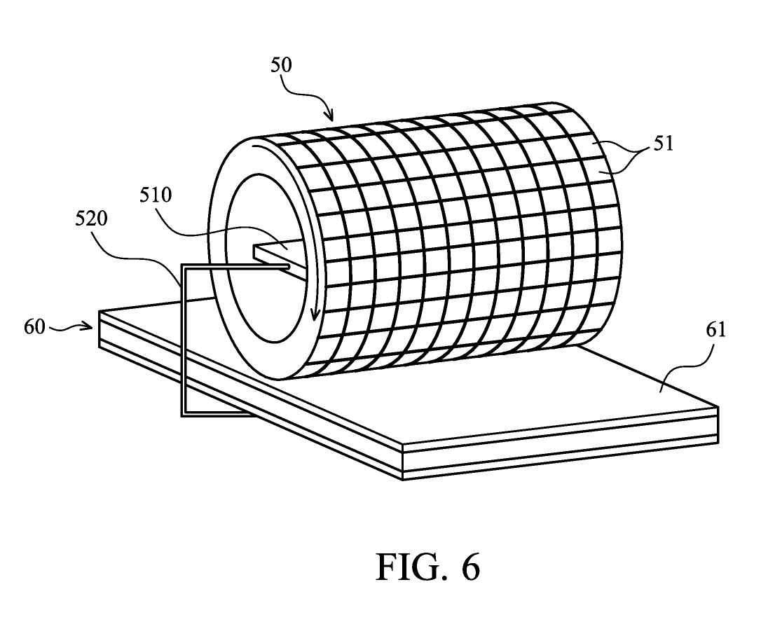

Referring to FIG. 6, another embodiment of a data writing device 50 comprises a hollow writerhead with a driving circuit 510 disposed therein. The driving circuit 510 electrically connects to a lower electrode layer of a multistable display 60 through the conductive wire 520 or a probe to generate a reference voltage. A plurality of electrodes 51 are arranged in a matrix form on the outer surface of the writerhead. The electrodes 51 in FIG. 6 are elastic, electrically independent from each other, and connected to the driving circuit 510. In this embodiment, the data writing device 50 can move along a first non-electrode surface 61 of the multistable display 60. The image data of the multistable display 60 can be updated by the electrodes 51 directly contacting the non-electrode surface 61.

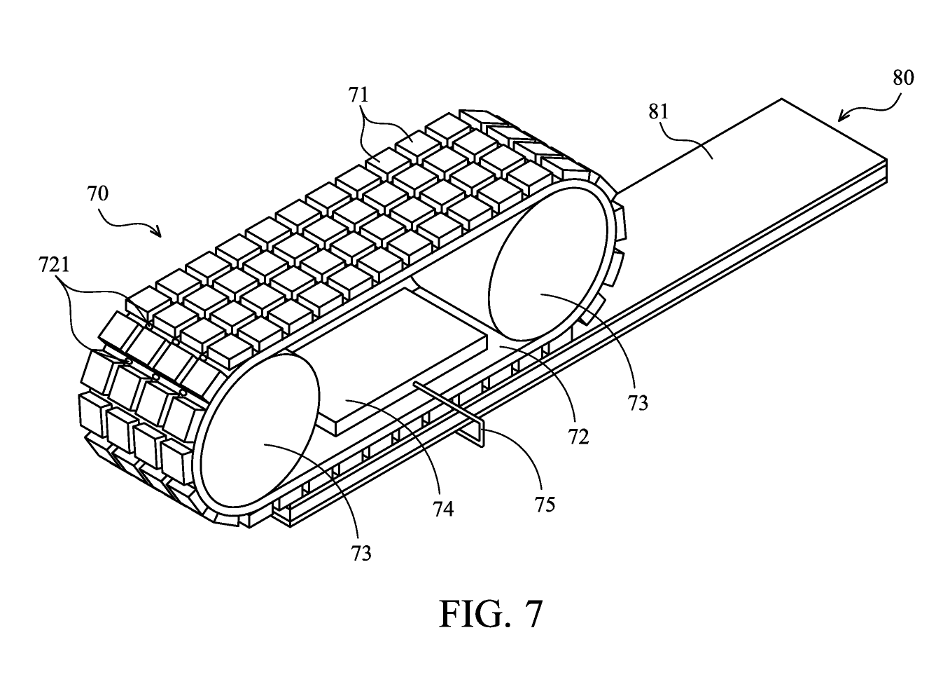

Referring to FIG. 7, another embodiment of a data writing device 70 comprises a writerhead with a caterpillar mechanism. A plurality of elastic electrodes 71 are arranged in a matrix form on a caterpillar band 72 of the writerhead. A driving circuit 74 is received in the caterpillar band 72 and electrically connected to the electrodes 71 to respectively provide a driving voltage signal to each of the electrodes 71. As shown in FIG. 7, the driving circuit 74 further connects to a lower electrode layer of a multistable display 80 to generate a reference voltage.

In this embodiment, the caterpillar band 72 is driven by two rollers 73, such that the data writing device 70 progresses through a non-electrode surface 81 of the multistable display 80. Hence, the image data of the multistable display 80 can be rapidly updated by the electrodes 71 directly in contact with the non-electrode surface 81. As shown in FIG. 7, the caterpillar band 72 has at least an exhaust hole 721 in communication with a vacuum pump. When the electrodes 71 contact the non-electrode surface 81, the vacuum pump evacuates the air from the gap between the caterpillar band 72 and the non-electrode surface 81. Hence, negative pressure is produced between the caterpillar band 72 and the non-electrode surface 81 to ensure close contact therebetween.

The invention provides a multistable display system and a method for writing image data on a multistable display. The multistable display system comprises a multistable display, a data writing device, and a sensor. The data writing device comprises a plurality of electrodes for writing the pixels of the multistable display, wherein each of the pixels corresponds to at least two of the electrodes. The sensor can detect a position of the writehead relative to the multistable display, and the electrodes of the data writing device can provide a corresponding driving voltage signal to each of the pixels, so as to update the image data of the multistable display. Since the invention does not need complex mechanisms for alignment, manufacturing costs are saved. Additionally, the invention can rapidly update the image data according to the required resolution, thus improving efficiency and flexibility of a multistable display.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A multistable display system, comprising:
a multistable display, comprising a plurality of pixels;
a data writing device, comprising a writehead and a driving circuit electrically connected to the writehead, wherein the writehead is movable relative to the multistable display and comprises a plurality of electrodes for writing the pixels of the multistable display, wherein each of the pixels corresponds to at least two of the electrodes; and
a sensor, detecting the position of the writehead relative to the multistable display and transmitting a control signal to the driving circuit, wherein the driving circuit respectively provides a driving voltage signal to the electrodes according to the control signal, so as to update the pixels of the multistable display.

2. The multistable display system as claimed in claim 1, wherein the plurality of electrodes are electrically independent from each other.

3. The multistable display system as claimed in claim 1, wherein the electrodes comprise elastic conductive material.

4. The multistable display system as claimed in claim 1, wherein the adjacent electrodes have a first distance therebetween, and the adjacent pixels have a second distance exceeding the first distance.

5. The multistable display system as claimed in claim 1, wherein the data writing device further comprises a plurality of brushes connecting the electrodes with the driving circuit.

6. The multistable display system as claimed in claim 1, wherein the data writing device is disposed across the multistable display to provide an electric field from opposite sides thereof.

7. The multistable display system as claimed in claim 1, wherein the driving circuit provides the driving voltage signal to each of the electrodes according to a required resolution for the multistable display.

8. The multistable display system as claimed in claim 1, wherein the writehead has a block-shaped or cylinder structure.

9. The multistable display system as claimed in claim 8, wherein the driving circuit is received in the writehead.

10. The multistable display system as claimed in claim 8, wherein the writehead further comprises a plurality of insulating portions to insulate the electrodes from each other.

11. The multistable display system as claimed in claim 10, wherein the electrodes and the insulating portions are disposed on an outer surface of the writehead.

12. The multistable display system as claimed in claim 10, wherein the insulating portions are elastic.

13. The multistable display system as claimed in claim 10, wherein the insulating portions comprise rubber.

14. The multistable display system as claimed in claim 1, wherein the driving circuit receives desired image data by one time download or wireless data transmission to update the image data of the multistable display.

15. The multistable display system as claimed in claim 1, wherein the driving circuit provides the driving voltage signal to each of the electrodes according to a detection result from the sensor.

16. The multistable display system as claimed in claim 1, wherein the multistable display system further comprises an erase head to remove the image data of the multistable display.

17. The multistable display system as claimed in claim 16, wherein the erase head removes the image data of the multistable display by moving along the multistable display.

18. The multistable display system as claimed in claim 1, wherein the multistable display further comprises an electrode layer, a plurality of contact electrodes, and a multistable medium layer disposed between the electrode layer and the contact electrodes, wherein the contact electrodes are electrically independent from each other and individually define the pixels.

19. The multistable display system as claimed in claim 18, wherein the multistable medium layer comprises cholesterol liquid crystal material.

20. A method for writing image data on a multistable display, wherein the multistable display includes a plurality of pixels, and the method comprises:
providing a data writing device, wherein the data writing device is movable relative to the multistable display and comprises a writehead having a plurality of electrodes for writing the pixels of the multistable display, and each of the pixels corresponds to at least two of the electrodes;
detecting the position of the writehead relative to the multistable display; and
providing a driving voltage signal to each of the electrodes according to the positions of the writehead and the multistable display, so as to update the pixels of the multistable display.

21. The method as claimed in claim 20, wherein the electrodes comprise elastic conductive material.

22. The method as claimed in claim 20, wherein the adjacent electrodes have a first distance therebetween, and the adjacent pixels have a second distance exceeding the first distance.

23. The method as claimed in claim 20, wherein the data writing device adjusts the resolution of the multistable display by altering the writing frequency thereof.

24. The method as claimed in claim 20, wherein the writehead has a block-shaped or cylinder structure.

25. The method as claimed in claim 20, wherein the writehead further has a plurality of insulating portions to insulate the electrodes from each other.

26. A multistable display system, comprising:
a multistable display, having a first non-electrode surface; and
a data writing device, comprising a writehead and a driving circuit electrically connected to the writehead, wherein the writehead is movable relative to the multistable display and comprises a plurality of electrodes made of elastic conductive material for writing image data on the multistable display, wherein the first non-electrode surface faces toward the data writing device.

27. The multistable display system as claimed in claim 26, wherein the multistable display further has a second non-electrode surface, and the data writing device further comprises two writeheads corresponding to the first and second non-electrode surfaces for writing image data on the multistable display.

28. The multistable display system as claimed in claim 26, wherein the writehead has a cylinder structure, and the electrodes are arranged in a matrix form and disposed on an outer surface of the cylinder structure for writing image data on the multistable display.

29. The multistable display system as claimed in claim 26, wherein the writehead further comprises a caterpillar band and two rollers, and the electrodes are arranged in a matrix form and disposed on the caterpillar band, wherein the caterpillar band is driven by the rollers to move through the first non-electrode surface.

30. The multistable display system as claimed in claim 29, wherein the caterpillar band has at least an exhaust hole communicating with a vacuum pump, and the vacuum pump produces negative pressure between the writehead and the multistable display to ensure close contact therebetween.
